(19) United States
(12) Patent Application Publication
(10) Pub. No.: US 2008/0141343 A1
(43) Pub. Date: Jun. 12, 2008

(54) METHOD, SYSTEM AND APPARATUS FOR ACCESS CONTROL

(75) Inventors: Swaroop Sampath KUMAR, Singapore (SG); Hidenori ISHII, Osaka (JP); Pek Yew TAN, Singapore (SG)

Correspondence Address: DICKINSON WRIGHT PLLC, 1901 L STREET NW, SUITE 800, WASHINGTON, DC, 20036, US

(73) Assignee: MATSUSHITA ELECTRIC INDUSTRIAL CO., LTD., OSAKA (JP)

(21) Appl. No.: 11/840,072

(22) Filed: Aug. 16, 2007

Related U.S. Application Data
(60) Provisional application No. 60/837,907, filed on Aug. 16, 2006.

(51) Int. Cl. G06F 15/16

(52) U.S. Cl. 726/3

(57) ABSTRACT

A system of access control in a data communication network comprising of a privacy unaware Guest Device, a privacy unaware Slave device, a PN Server and a Master Device wherein the access of a privacy unaware Slave device by a privacy unaware Guest Device is restricted by a PN Server, which intercepts all session initiations concerned with the Slave Device. A method of access control of the system comprises the steps of Access request by Guest Device privacy mode processing by PN Server privacy decision processing by Master Device; and privacy response processing by PN Server.

### TECHNICAL FIELD

The present invention pertains to the field of telecommunications in a packet-switched communications network. More particularly, it concerns access control in a Session Initiation Protocol (SIP) environment.

### DISCLOSURE OF INFORMATION OF PRIOR ART DOCUMENTS

[Non-patent document 1] 3GPP TS 22.259v7.1, “Service Requirements for Personal Network Management”

[Non-patent document 2] 3GPP TS 23.228 v7.4, “IP Multimedia Subsystem” [Non-patent document 3] J. Rosenberg, et al., “SIP: Session Initiation Protocol”, IETF RFC 3261.

[Non-patent document 4] R. Sparks, “The Session Initiation Protocol (SIP) Refer Method”, IETF RFC 3515.

### [Patent Application 1] Bodlaender, Maarten, P., et. al., “Different permissions for a Control Point in a Media Provision Entity”, Koninklijke Philips Electronics N.V., International publication number WO2005/046166A1.

[Patent Application 2], Chia, Pei Yen, et. al., “Network System and Method for providing ad-hoc access environment”, Matsushita Electric Industrial Co. LTD, International publication number WO 2005/116841 A1.

### BACKGROUND AND PRIOR ART

Many communication devices today communicate over the IP protocol, and in particular using SIP or session initiation protocol. SIP has been the chosen protocol for signaling in 3GPP as well.

As more and more devices gain networking capabilities, the need for a user to manage these multiple devices arises. Such a work item has been undertaken in 3GPP under the scope of Personal Network Management. Here, a number of user's devices are registered with the service provider who enables simple management procedures such as redirection & privacy services. Since the service provider has a database containing the features of the devices, and the configuration details of the devices, the network gains a powerful processing capabilities pertaining to the sessions that the devices are involved in.

In this patent, we look at the user requirement of keeping some of his devices private. Privacy in this specification will refer to this aspect, where access to these private devices is controlled. This means that user is able to allow or block certain individuals from accessing those particular devices. In addition, the user may be able to filter the type of sessions that the private devices take part in.

To enable such a control, [Patent Application 1] specifies two or more sets of permission lists in relation to assets associated with a media provision entity. The control point wanting to access these assets is required to register with the security console to gain the permission before doing so. The security console is controlled by the owner of the asset. This would require the control point to be aware of the security console, that is the need for an interface between the security console and the control point arises. So, in the case of the user changing his security console from one device to another (for example, security console being his mobile changed to using PC as a security console) each time the control point registers the new security console may be need to be revealed. Also, when we think in terms of sessions, the process for a control point to access a media asset involves initial access, then requiring registering with the security console, and then again accessing the media. This involves many transactions to achieve a single objective of trying to access a media. Also, older versions of control points may not be aware of these procedures and thus will be unable to access the media.

[Patent application 2] is another approach, where the authorization controller enables ad-hoc access without need of static registration information. There is a need for an interface between the foreign mobile node and the authorization controller. This interface allows the setup of an ad-hoc access by the foreign mobile node. So, this interface has to be introduced in the foreign mobile node. Also, the end devices or home devices stay hidden behind the authorization controller. This again introduces the need for the foreign mobile node to go through multiple transactions in order to start a session with an end device. For example, in this case the Guest would first need a transaction to be registered. Once it receives the acknowledgement of being registered, it would need to need to initiate a session with the particular home device. The simpler scenario would be when the Guest Device initiates a session normally, and the terminating side handles the privacy. The simpler scenario would be when the Guest Device initiates a session normally, and the terminating side handles the privacy, thus enabling both privacy in single transaction and supporting legacy Guest Devices or simply legacy devices.

Today, once devices gain network connectivity, generally they are able to connect to another destination given that they know how to reach them (IP address, SIP url, etc). Hence by introducing other mid-session or pre-session procedures to be handled by the foreign mobile node or the control point, support of legacy devices may not be possible. In addition, by requiring new security procedures, redundancy is created in protocol as far as 3gpp communications go, since 3gpp already provides inherent security based on the use of USIM (Universal SIM). So, by taking advantage of the inherent security implementation and the existing end-to-end protocols already running in today's devices, it should be able to provide a wider solution to privacy service, thus avoiding the problems in needing multiple transactions, new interfaces & no support of legacy or privacy unaware devices.

### SUMMARY

A system of access control in a data communication network comprising a privacy unaware Guest Device, a privacy unaware Slave device, a PN Server and a Master Device wherein the access of a privacy unaware Slave device by a privacy unaware Guest Device is restricted by a PN Server, which intercepts all session initiations concerned with the Slave Device. A system of access control wherein the PN Server comprises of an Access Control List (ACL) which contains list of registered Guest Devices an Access Control Processing Unit (ACPU) which performs processing with respect to privacy.

The ACPU of the PN Server verifies the relation between the Master Device and the privacy unaware Slave Device before configuring the privacy unaware Slave device as private. The ACPU of the PN Server performs privacy filter criteria check of session initiation access requests directed to the privacy unaware Slave Device, which triggers access control processing. The ACPU of the PN Server constructs a Query directed at the Master Device, when the information stored at the ACL is insufficient for further processing.

The Master Device consists of the Privacy processing Unit (PPU), which communicates with the ACPU of the PN Server in enabling access control. The PPU performs configuration procedures with the ACPU of the PN Server in order configure the privacy unaware Slave Device as private. The PPU displays access request information to the user in text or graphical form.

A method of access control of the system in claim 1, comprises the steps of access request by Guest Device, privacy mode processing by PN Server, privacy decision processing by Master Device and privacy response processing by PN Server.

A method of privacy mode processing by PN Server comprises the steps of ACPU of PN Server checks the destination ID of the access request ACPU checks if the destination ID is private. A method of privacy mode processing by PN Server further comprises the step of ACPU of PN Server checking the ACL of the PN Server if the source of the access request is registered as a Guest. A method of privacy mode processing by PN Server further comprises the step of retrieving the Master ID of the particular privacy unaware Slave Device. A method of privacy mode processing by PN Server further comprises the step of the ACPU of the PN Server constructing a query which is sent to the Master Device. A method of privacy mode processing by PN Server further comprises the step of the ACPU of the PN Server attaching access request information. A method of constructing a query by ACPU of the PN Server, wherein the Query is in the form of a modified INVITE message, with the destination device as the Master Device. A method of constructing a query by ACPU of the PN Server wherein the Query is in the form of a REFER message, with the refer-to header pointing to the attachment holding the access request information. A method of privacy response processing by the PN Server comprises the step of checking the attachment of the response message sent by the Master Device.

A method of privacy decision processing by the Master Device comprises the step of checking the attachment in the Query message. A method of privacy decision processing by the Master Device comprises the step wherein the Query message is in the form of a modified INVITE message. A method of privacy decision processing by the Master Device wherein the Query message is in the form of a REFER message. A method of privacy decision processing by the Master Device comprises the step of checking if the access request was directed to its privacy unaware Slave Device. A method of privacy decision processing by the Master Device comprises the step of showing the access request information in text or graphical form to the user. A method of privacy decision processing by the Master Device comprises the step of requesting the user if the decision of access is to be made static. A method of privacy decision processing by the Master Device comprises the step of constructing a response message. A method of privacy decision processing by the Master Device comprises the step of attaching the user response to the response message. A method of constructing a response comprises of the step wherein the response is in the form of a REDIRECT message with the contact header containing the identity of the privacy unaware Slave device. A method of constructing a response wherein the response is in the form of a NOTIFY message with user response added as an attachment to the message.

A method of checking the response message of the Master Device wherein the response is in the form of a REDIRECT message. A method of checking the response message of the Master Device, wherein the response is in the form of a NOTIFY message. A method of privacy response processing by the PN Server, further comprises the step of checking the response message for the static attribute. A method of privacy response processing by the PN Server, further comprises the step of storing the attributes of the response message if the static attribute is present. A method of privacy response processing by the PN Server further comprises the step of sending the INVITE message to the privacy unaware Slave Device if access has been approved by the Master Device.

### BRIEF DESCRIPTION OF DRAWINGS

The above and other objects and features of the invention will appear more fully hereinafter from a consideration of the following description taken in connection with the accompanying drawing wherein one example is illustrated by way of example, in which;

FIG. 1 is a diagram illustrating the overall system of an Access Control system. It consists of Guest Devices 1, Privacy unaware Slave Devices 3, and privacy aware Slave Devices 2, PN Server 4 and the Master Device 5.

FIG. 2 is a diagram illustrating the preferred System for access control, consisting of a Guest Device 1, a PN Server 4, a Slave Device 3, and a Master Device 5, according to the preferred embodiment of the invention.

FIG. 3 is a diagram illustrating second embodiment for access control, consisting of a Guest Device 1, privacy aware Slave Device 2, and a Master Device 5, according to the second embodiment of the invention.

FIG. 4 is a diagram illustrating the third embodiment for access control consisting of a Guest Device 1, privacy aware Slave Device 2, a PN Server 4 and a Master Device 5, according to the third embodiment of the invention.

FIG. 5 is a diagram illustrating the configuration of a device as a Slave Device 3 by the Master Device 5 using the PN Server 4, according to the fourth embodiment of the invention.

FIG. 6 is a diagram illustrating the session initiation sequence between the Guest Device 1 and the Slave Device 3, with the access control processing performed by the PN Server 4 and the Master Device 5, according to the fourth embodiment of the invention.

FIG. 7 is a diagram illustrating the privacy mode processing of step 31, performed by the PN Server 4 initiating the access control processing, according to the fourth embodiment of the invention.

FIG. 8 is a diagram illustrating the privacy decision processing of step 33, performed by the Master Device 5 processing the access control information sent by the PN Server 4, according to the fourth embodiment of the invention.

FIG. 9 is a diagram illustrating the privacy response processing of step 35, performed by the PN Server 4 processing the response of the Master Device 5 to the access control information, according to the fourth embodiment of the invention.

FIG. 10 is a diagram illustrating the configuration of a device as a privacy aware Slave Device 2 by the Master Device 5 directly, according to the fifth embodiment of the invention.

FIG. 11 is a diagram illustrating the session initiation sequence between the Guest Device 1 and the privacy aware Slave Device 2, with the access control processing performed by the privacy aware Slave Device 2 and the Master Device 5, according to the fifth embodiment of the invention.

FIG. 12 is a diagram illustrating the privacy mode processing of step 111, performed by the Slave initiating the access control processing, according to fifth embodiment of the invention.

FIG. 13 is a diagram illustrating the privacy decision processing of step 115, performed by the Master Device 5 processing the access control information sent by the privacy aware Slave Device 2, according to the fifth embodiment of the invention.

FIG. 14 is a diagram illustrating the configuration of a device as a privacy aware Slave Device 2 by the Master Device 5 indirectly, according to the sixth embodiment of the invention.

FIG. 15 is a diagram illustrating the capability check of step 130, performed by the PN Server 4 processing the Slave configuration information sent by the Master, according to the sixth embodiment of the invention.

FIG. 16 is a diagram illustrating the session initiation sequence between the Guest Device 1 and the Slave Device 3, with the access control processing performed by the PN Server 4 and the Master Device 5, with pre-configuration check by the privacy aware Slave Device 2, according to the sixth embodiment of the invention.

FIG. 17 is a diagram illustrating the configuration check of step 150, performed by the privacy aware Slave Device 2 performing the steps of pre-configuration check after receiving an INVITE message, according to the sixth embodiment of the invention.

FIG. 18 is a diagram illustrating the session initiation sequence between the Guest Device 1 and the privacy aware Slave Device 2, with the access control processing performed by the Guest Device 1 and the Master Device 5, with pre-configuration check by the privacy aware Slave Device 2, according to the seventh embodiment of the invention.

FIG. 19 is a diagram illustrating the session initiation sequence between the Guest Device 1 and the Slave Device 3, with the access control processing performed by the PN Server 4 and the Master Device 5, by the use of INVITE and REDIRECT messages between the PN Server 4 and the Master Device 5, according to the eighth embodiment of the invention.

FIG. 20 is a diagram illustrating the privacy mode processing of step 180, performed by the PN Server 4 initiating the access control processing using the modified INVITE message, according to the eighth embodiment of the invention.

FIG. 21 is a diagram illustrating the privacy decision processing of step 182, performed by the Master Device 5 processing the access control information present in the modified INVITE message sent by the PN Server 4, according to the eighth embodiment of the invention.

FIG. 22 is a diagram illustrating the privacy response processing of step 184, performed by the PN Server 4 processing the REDIRECT response of the Master Device 5 to the access control information sent in the modified INVITE message, according to the eighth embodiment of the invention.

FIG. 23 is a diagram illustrating the session initiation sequence between the Guest Device 1 and the Slave Device 3, with the access control processing performed by the privacy aware Slave Device 2 and the Master Device 5, by the use of REDIRECT messages between the Slave and the Master Device 5, according to the ninth embodiment of the invention.

FIG. 24 is a diagram illustrating the privacy mode processing of step 220, performed by the privacy aware Slave Device 2 initiating the access control processing using the REDIRECT message, according to ninth embodiment of the invention.

FIG. 25 is a diagram illustrating the privacy decision processing of step 222, performed by the Master Device 5 processing the access control information present in the REDIRECT message sent by the privacy aware Slave Device 2, according to the ninth embodiment of the invention.

FIG. 26 is a diagram illustrating the privacy response processing of step 224, performed by the privacy aware Slave Device 2 processing the REDIRECT response of the Master Device 5 to the access control information sent in the previous REDIRECT message, according to the ninth embodiment of the invention.

FIG. 27 is a diagram illustrating the session initiation sequence between the Guest Device 1 and the Slave Device 3, with the access control processing performed by the PN Server 4 and the Master Device 5, by the use of REFER and NOTIFY messages between the PN Server 4 and the Master Device 5, according to the tenth embodiment of the invention.

FIG. 28 is a diagram illustrating the privacy mode processing of step 260, performed by the PN Server 4 initiating the access control processing using the REFER message, according to the tenth embodiment of the invention.

FIG. 29 is a diagram illustrating the privacy decision processing of step 262, performed by the Master Device 5 processing the access control information present in the REFER message sent by the PN Server 4, according to the tenth embodiment of the invention.

FIG. 30 is a diagram illustrating the privacy response processing of step 264, performed by the PN Server 4 processing the NOTIFY response of the Master Device 5 to the access control information sent in the previous REFER message, according to the tenth embodiment of the invention.

FIG. 31 is a diagram illustrating the session initiation sequence between the Guest Device 1 and the privacy aware Slave Device 2, with the access control processing performed by the privacy aware Slave Device 2 and the Master Device 5, by the use of REFER and NOTIFY messages between the privacy aware Slave Device 2 and the Master Device 5, according to the eleventh embodiment of the invention.

FIG. 32 is a diagram illustrating the privacy mode processing of step 300, performed by the privacy aware Slave Device 2 initiating the access control processing using the REFER message, according to eleventh embodiment of the invention.

FIG. 33 is a diagram illustrating the privacy decision processing of step 302, performed by the Master Device 5 processing the access control information present in the REFER message sent by the privacy aware Slave Device 2, according to the eleventh embodiment of the invention.

FIG. 34 is a diagram illustrating the privacy response processing of step 304, performed by the privacy aware Slave Device 2 processing the NOTIFY response of the Master Device 5 to the access control information sent in the previous REFER message, according to the eleventh embodiment of the invention.

### FULL DESCRIPTION

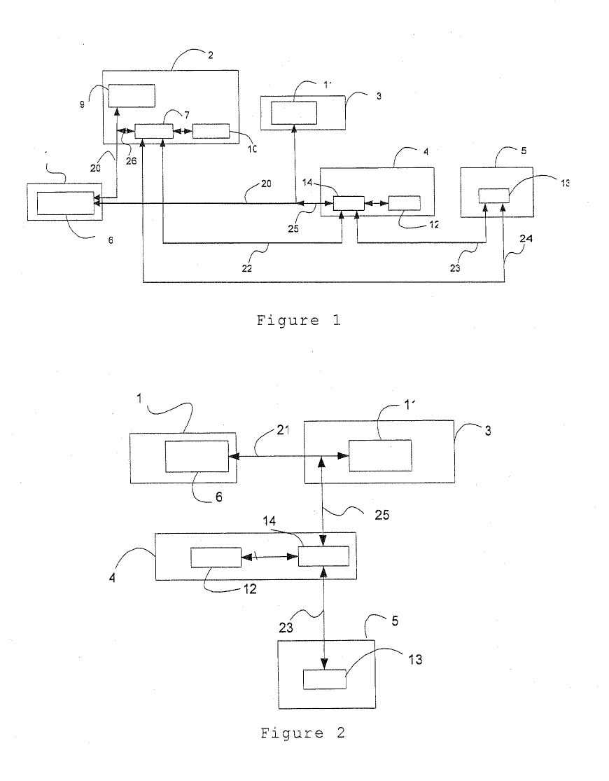

FIG. 1, is the overall system for access control, consisting of a privacy unaware Guest Device 1 or simply Guest Device 1, a PN Server 4, a privacy unaware Slave Device 3, a privacy aware Slave Device 2 and a Master Device 5.

A Guest Device 1 is a normal communication device with a software/hardware block 6 to support an application which may include voice, video, but not limited to these. It is assumed to be unaware of privacy.

A PN Server 4 is an access control entity that is point of contact en route the Slave Devices 3 (both privacy unaware and privacy aware). It serves as a database consisting of information relating to the devices that a user owns, and related settings. The settings may relate to the capabilities of these devices, the service specific settings such as redirection/call forwarding settings, or other service specific settings. The PN Server 4 is triggered when a session related to any of these settings is initiated. It then processes the session initiation to achieve the objective of the service it is being used for. In this description, we discuss the service of privacy. That is given that the user has multiple devices in his subscription, he may restrict the access of some of his devices. For example, this restriction may be in the form of a buddy list. These privacy settings are stored in the Access Control List, which is usually configured by the user himself. The PN Server 4 also has an Access Control Unit which handles not only processing of this list but also processing of session initiation procedures when the Access Control List does not suffice to complete the processing. For example, when the Access Control List does not have details regarding the user trying to access a Slave Device 3, the Access Control Unit contacts the Master Device 5 on instructions to process the request. To manage this, he nominates one of his devices as a Master Device 5, which is usually his handheld phone, but not limited to this. All the other devices can be Slave Device 3. Each of these Slave Device 3 may have privacy settings which govern who and what kind of sessions they can participate in. The settings or Access Control List (ACL) may be stored either in the Slave Device 3 itself, making it a privacy aware Slave Device 2 or maybe stored at the PN Server 4, or maybe stored at both the PN Server 4 and the Slave Device 3.

In this description, user devices other than the Master Device 5 without the ACL or capability of processing an ACL are referred to as privacy unaware Slave Device 3 or simply Slave Device 3. Slave Devices also have a software/hardware block 9 which perform application specific processing such as voice, video, etc, but not limited to these. User devices with the ACL or capability to process ACL will be referred to as privacy aware Slave Device 2. The functional unit processing the ACL and other access control procedures is referred to as Access Control Processing Unit (ACPU). Thus the system is capable of supporting Guest Devices 1 (privacy unaware), Slave Device 3 (privacy unaware), privacy aware Slave Device 2, PN Server 4 and Master Device 5.

There are many interfaces shown in FIG. 1. These indicate the required protocols that need to be present in the respective devices. Interface 20 is the existing interface between two communication devices. Protocols in this interface may be SIP or other session related protocols, but not limited to these. It is to be noted that the only interface that the Guest Device 1 with respect to this service is 20. Therefore all Guest Devices 1 with basic session protocols could be supported. The same logic holds for privacy unaware Slave Device 3. Interface 24 exists between the ACPU 7 of the privacy aware Slave Device 2 and the privacy processing unit (PPU 13) of the Master Device 5. This interface is triggered when the ACL 7 does not have enough information for processing the session initiation. The ACPU 7 then sends the required session request information to the PPU 13 for further processing. The PPU 13 processes the request, and provides the user to make a decision regarding the call. Once the decision is made by the PPU 13, the PPU 13 sends this decision data to the ACPU 7. The ACPU 7 then acts according to the information sent.

Interface 25 is an invisible interface handled by the PN Server 4, mediating interface 20. It is invisible since both the Guest Device 1 and the Slave Device 3 (end devices) are not aware of this interface. The configuration of this interface is such that all signaling on the interface 20 goes through filter checks. The filter criteria as far as this specification goes is privacy. Once the Slave Device 3 is configured as private by the user, all session requests to the Slave Device 3 are filtered based on privacy. Once triggered, the ACPU 14 of the PN Server 4 interacts with the ACL 12 of the PN Server 4 and the PPU 13 to continue processing the call. Interface 26 is an interface handled by the ACPU 7 of the privacy aware Slave Device 2 and, mediating interface 20. The privacy aware Slave Device 2 checks session requests such that all signaling on the interface 20 goes through the ACPU 7.

Interface 23 exists between the ACPU 14 of the PN Server 4 and the privacy processing unit (PPU 13) of the Master Device 5. This interface is triggered when the ACL 12 does not have enough information for processing the session initiation. The ACPU 14 then sends the required session request information to the PPU 13 for further processing. The PPU 13 processes the request, and provides the user to make a decision regarding the call. Once the decision is made by the PPU 13, the PPU 13 sends this decision data to the ACPU 14. The ACPU 14 then acts according to the information sent. Interface 23 also handles configuration information between the Master Device 5 and the PN Server 4. The Master Device 5 uses this interface to set the privacy states of the Slave Device 3.

Interface 22 is an interface between the ACPU 14 of the PN Server 4 and the ACPU 7 of the privacy aware Slave Device 2. This handles the configuration information when both PN Server 4 and privacy aware Slave Device 2 have access control processing units. This interface allows the Slave Device 3 to be aware of the PN Server 4 existence in the network, thus avoiding the access control processing twice.

FIG. 2, is the preferred or first embodiment of the invention. It consists of a Guest Device 1 which need not be aware of privacy, Master Device 5 which performs access control processing, PN Server 4 that stores the ACL 12 and ACPU 14, and the Slave Device 3 which also need not be aware of privacy. The interfaces involved in this embodiment are 21, 23 and 25. This embodiment provides full support of privacy unaware devices, while providing privacy service. Also, a central PN Server 4 managed by a service provider allows many users to make use of this service rather than have this processing at end devices. This may also provide the service provider motivation to enable this service and derive an income from it. More details of the first embodiment can be found in the fourth, sixth, eighth and tenth embodiments.

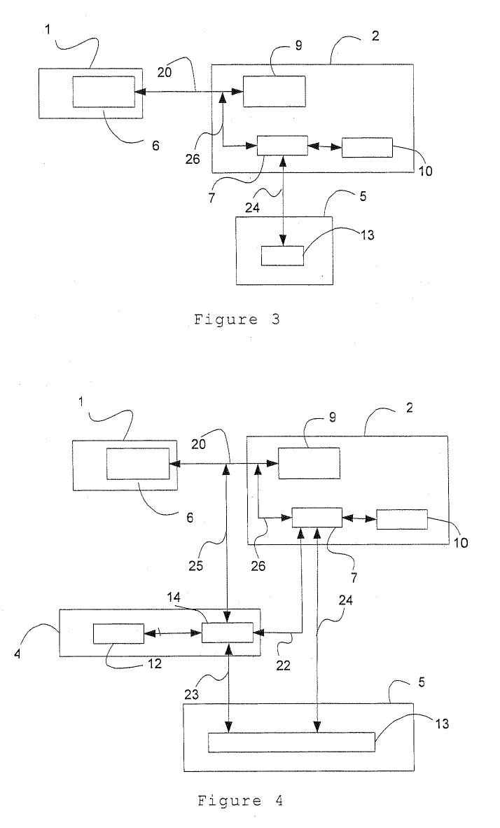

FIG. 3, is the second embodiment of the invention. This system supports privacy processing in the end devices or privacy aware Slave Device 2. This system is useful in networks not wishing to implement privacy service, and users yet wanting to make use of this service. In this case, privacy support by privacy aware Slave Device 2 will enable the service. The interfaces involved in this embodiment are 20, 24 and 26. More details of the second embodiment can be found in the fifth, seventh, ninth and eleventh embodiments.

FIG. 4, is the third embodiment of the invention. This system supports privacy processing both in end devices and at the network (PN Server 4). This system allows for the case when the user has enabled privacy processing both at the network and his privacy aware Slave Device 2. To prevent redundant processing of access control procedures, the PN Server 4 and the privacy aware Slave Device 2 are made aware of each other's capability. This allows enabling a single complete procedure to achieve privacy. The interfaces involved in this embodiment are 20, 22, 23, 24, 25 and 26. More details can be found in the sixth and seventh embodiments.

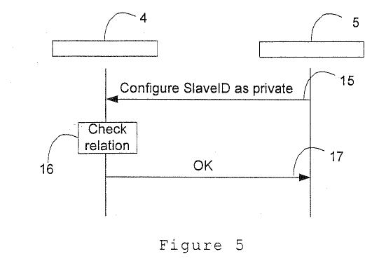

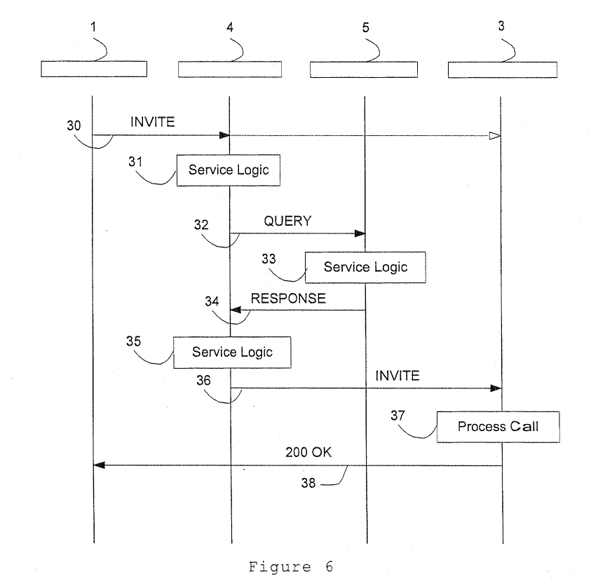

FIG. 5, is the configuration sequence for the fourth embodiment. Here, we assume that the Slave Device 3 do not have privacy processing. The user is aware of privacy service by the network. In step 15, he requests for configuring his Slave Device 3 as private using the device he has configured as Master. The PN Server 4 receives this request and processes it in step 16. First it checks the relation between the Master Device 5 Identity and the Slave Device 3 Identity, whether such a configuration already exists. If so, it stores privacy setting of the Slave Device 3 into its database. It confirms this step by an acknowledgement in step 17.

FIG. 6, is the sequence diagram of the fourth embodiment of the invention. This illustrates the session initiation procedures involved in implementing privacy service by the network by hosting a PN Server 4. Guest Device 1 sends an INVITE message to the Slave Device 3 as the destination in step 30. This message is intercepted by the PN Server 4 using the interface 25. The PN Server 4 then processes the request based on the ACL 10, as privacy mode processing in step 31. If the privacy mode processing in step 31 decides to continue with privacy processing, a query is sent with access request information in step 32. In step 33, the query is processed by the privacy decision processing of Master Device 5. The privacy decision processing of step 33 processes the decision of the user, and formats it in the form of a response which is sent in step 34. This response is processed in the privacy response processing of step 35. If the response is positive, the INVITE message of step 30 is sent as normal to the Slave Device 3 in step 36. This message is processed as normally done by the Slave Device 3 protocol stack in step 37.

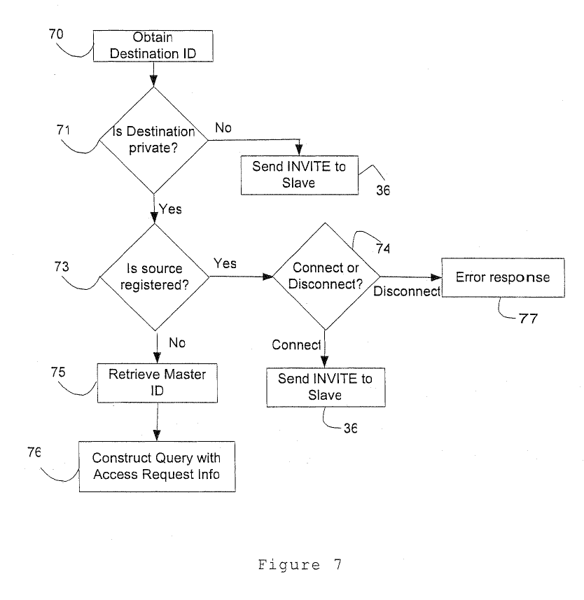

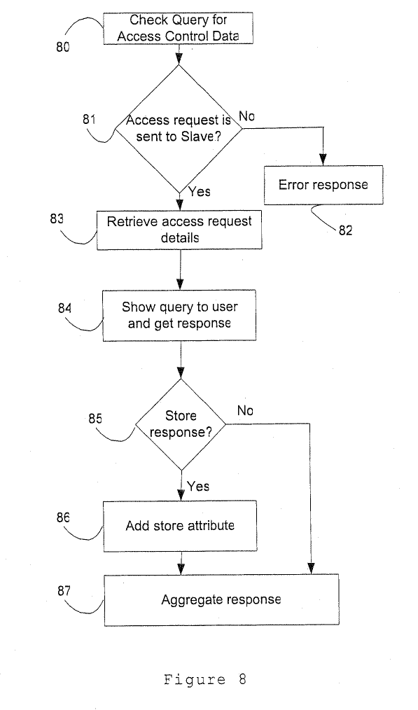

FIG. 7, is the steps involved in the privacy mode processing at step 31. First, the destination identity is obtained from the INVITE request as in step 70. Once this is done, a check is done whether the destination device has been configured as private.

If it is not configured as private, call is processed as normal as in step 36.

If private, another check is done whether the source device or identity is registered as a Guest already, as in step 73. This check is done to verify if the ACL 10 already contains information regarding the Guest. If is registered, or there is already some information regarding the Guest Device 1, a further check is done regarding the detail of the registration/configuration. This can be whether the call is to be connected or disconnected as in step 74. Other details may also be checked such as media information, QoS attributes, service specific filters, but not limited to these. If the entry is to disconnect the call, the PN Server 4 sends an error request as in step 77, usually in the form of a CANCEL message. If the entry is to connect the call, the PN Server 4 continues processing the call by sending the INVITE message to the Slave Device 3 as in step 36.

If the original device hasn't been registered as yet, the PN Server 4 retrieves the Master Device 5 for the particular destination device as in step 75, which is the Slave Device 3 as in this case. Using the access request information present in the initial INVITE, a query message is constructed by the PN Server 4 to be sent to the Master Device 5 as in step 76.

FIG. 8, is the steps involved in privacy decision processing step 33. The query is checked for access control information by the Master Device 5 as in step 80. When this information is present, it checks whether the detail present refers to its Slave Device 3 as in step 81. If it does not refer to its Slave Device 3, it may send an error report as in step 82. If the access control information does correspond to the Slave Device 3, the PPU 13 retrieves the relevant details from the attachment such as source device, session-type and other session/service relevant information as in step 83. Once these details are collected, the PPU 13 presents these details in graphical/text form to the user as in step 84, requesting his response to this session request. For example, a simple message such as X trying to access Y: Approve or Disapprove, may be shown, where X is the Identity of the Guest Device 1 and Y is the identity of the Slave Device 3. Another feature that could be added is the option to store the user's response as a static entry in the ACL 10 of the PN Server 4, as shown in step 85. If the user wishes to keep his decision as a static entry, this information is added onto the response, as in step 86. Finally the response of the user is aggregated and formed as in step 87.

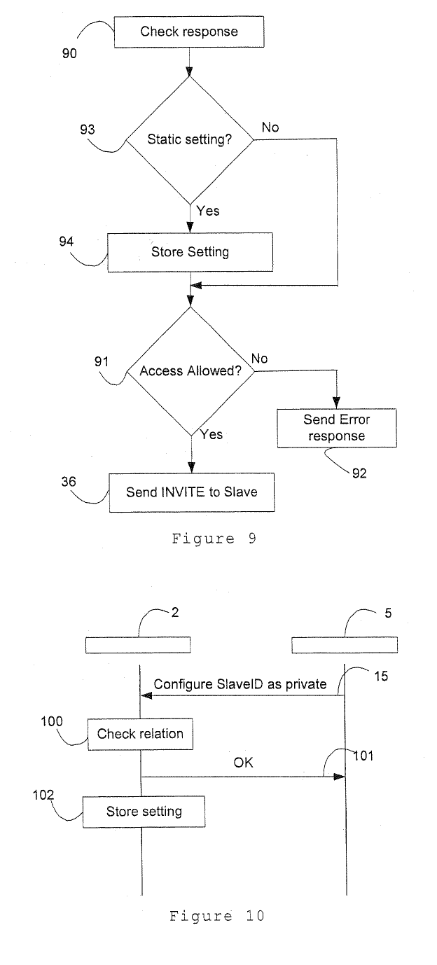

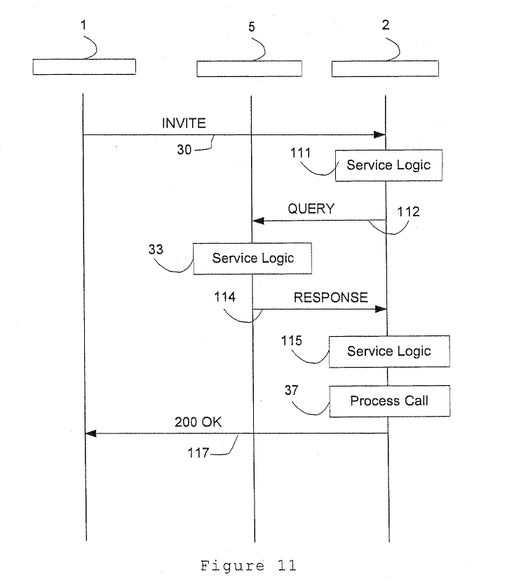

FIG. 9, is the flow chart description of the privacy response processing at step 35. Here, the PN Server 4 (ACPU 14) receives and checks the response from the Master Device 5 regarding the access control decision as in step 90. First, a check for the static attribute is checked in the response, as in step 93. If the static attribute is present, the relevant entries are stored onto the ACL 10. Next, a check on the actual decision is made, as in step 91. If access has been denied, an error response is sent as in step 92. This could be in form of a CANCEL message. If access is allowed, the INVITE message of step 30 is forwarded to the Slave Device 3, as in step 36.

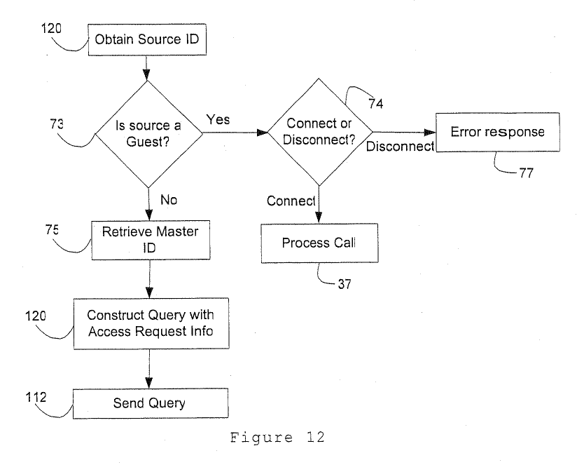

FIG. 10, is the configuration required in the fifth embodiment. Here, a Master Device 5 configures a privacy aware Slave Device 2 as private as in step 15. The privacy aware Slave Device 2 checks the relation between itself and the identity of the Master Device 5 as in step 100, and if required may perform authentication of the Master Device 5. The interface for this configuration is 24. An acknowledgement is sent when the relation is verified as in step 101. The setting may be stored in the local Access Control List or ACL 10, as in step 102.

FIG. 11, is the sequence diagram of the fifth embodiment of the invention. An INVITE message is sent from the Guest Device 1 to the privacy aware Slave Device 2 as in step 30. The privacy aware Slave Device 2 then performs privacy mode processing of step 111, which involves checking privacy status of the privacy aware Slave Device 2, checking registration status of the Guest Device 1, and further processing if required. If the ACPU 7 does not have enough information to process the request as far as privacy is concerned, the ACPU 7 constructs a Query message, and this is sent to the Master Device 5 as in step 112. The PPU 13 of the Master Device 5 processes the Query message as in privacy decision processing of step 33. The processing involves requesting the user to make a decision of the access request, and constructing a response message. Once the response message is created, it is sent to the privacy aware Slave Device 2 as in step 114. The privacy aware Slave Device 2 processes the response message as in privacy response processing of step 115. The result of the processing will enable the privacy aware Slave Device 2 to make a decision on whether to continue with call processing. If this is possible, call processing is continued as in step 37.

FIG. 12, is the steps involved in the privacy mode processing at step 111. First, the source identity is obtained from the INVITE request as in step 120. A check is done whether the source device or identity is registered as a Guest already, as in step 73. This check is done to verify if the ACL 10 already contains information regarding the Guest. If is registered, or there is already some information regarding the Guest Device 1, a further check is done regarding the detail of the registration/configuration. This can be whether the call is to be connected or disconnected as in step 74. Other details may also be checked such as media information, QoS attributes, service specific filters, but not limited to these. If the entry is to disconnect the call, the privacy aware Slave Device 2 sends an error request as in step 77, usually in the form of a CANCEL message. If the entry is to connect the call, the privacy aware Slave Device 2 continues processing the call as in step 37.

If the originating device hasn't been registered as yet, the privacy aware Slave Device 2 retrieves the Master Device 5 for the particular destination device as in step 75, which is the Master Device 5 as in this case. Using the access request information present in the initial INVITE, a query message is constructed by the privacy aware Slave Device 2 to be sent to the Master Device 5 as in step 120.

The privacy decision processing at the Master Device 5 at step 33 is the same as that in FIG. 8. The query is checked for access control information by the Master Device 5 as in step 80. When this information is present, it checks whether the detail present refers to its privacy aware Slave Device 2. If it does not refer to its privacy aware Slave Device 2, it may send an error report as in step 82. If the access control information does correspond to the privacy aware Slave Device 2, the PPU 13 retrieves the relevant details from the attachment such as source device, session-type and other session/service relevant information as in step 83. Once these details are collected, the PPU 13 presents these details in graphical/text form to the user as in step 84, requesting his response to this session request. For example, a simple message such as X trying to access Y: Approve or Disapprove, may be shown, where X is the Identity of the Guest Device 1 and Y is the identity of the Slave Device 3. Another feature that could be added is the option to store the user's response as a static entry in the ACL 12 of the PN Server 4, as shown in step 85. If the user wishes to keep his decision as a static entry, this information is added onto the response, as in step 86. Finally the response of the user is aggregated and formed as in step 87.

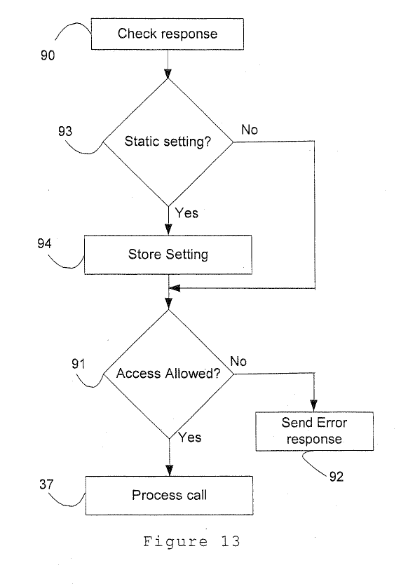

FIG. 13, is the flow chart description of the privacy response processing at step 115. Here, the privacy aware Slave Device 2 (ACPU 7) receives and checks the response from the Master Device 5 regarding the access control decision as in step 90. First, a check for the static attribute is checked in the response, as in step 93. If the static attribute is present, the relevant entries are stored onto the ACL 10. Next, a check on the actual decision is made, as in step 91. If access has been denied, an error response is sent as in step 92. This could be in form of a CANCEL message. If access is allowed, the call is processed further as in step 37.

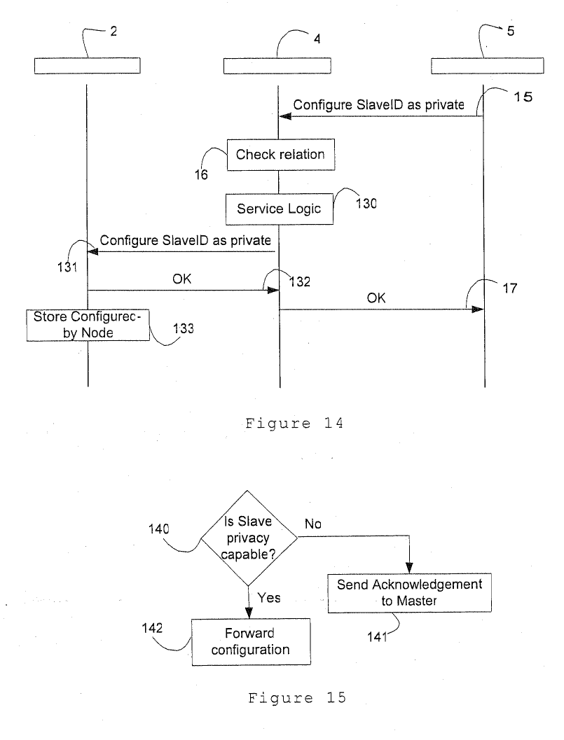

FIG. 14, is the configuration system for the sixth embodiment of the invention. This is the system where both the Slave Device 3 (privacy aware) and the PN Server 4 have ACPUs (Access Control Processing Units) to handle privacy. Therefore in order to prevent access control procedures from executing twice, information is shared between the PN Server 4 and the privacy aware Slave Device 2 about respective capabilities. In step 15, the user requests for configuring his Slave Device 3 as private using the device he has configured as Master over the interface 23. The PN Server 4 receives this request and processes it in step 16. First it checks the relation between the Master Device 5 Identity and the Slave Device 3 Identity, whether such a configuration already exists. If so, it stores privacy setting of the Slave Device 3 into its database. The PN Server 4 stores capabilities of all the devices that it controls. It performs a capability check in step 130 to process these privacy capabilities. Once it is aware that the Slave Device 3 is also privacy aware, it forwards the configuration information sent by the Master Device 5, over the interface 22. The privacy aware Slave Device 2 confirms this by sending an acknowledgement as in step 132. The ACPU 7 stores the attribute of configured-by-node in the ACL 10. As in this case, the configured-by-node is the PN Server 4. The PN Server 4 confirms the configuration of privacy aware Slave Device 2 as private by an acknowledgement in step 17.

FIG. 15, describes the capability check at step 130. First a check is performed by the PN Server 4, whether the Slave is privacy capable, as in step 140. If it not privacy capable, an acknowledgement is sent to the Master Device 5 as in step 17. If the Slave is privacy capable, the configuration information is forwarded to the privacy aware Slave Device 2 as in step 142.

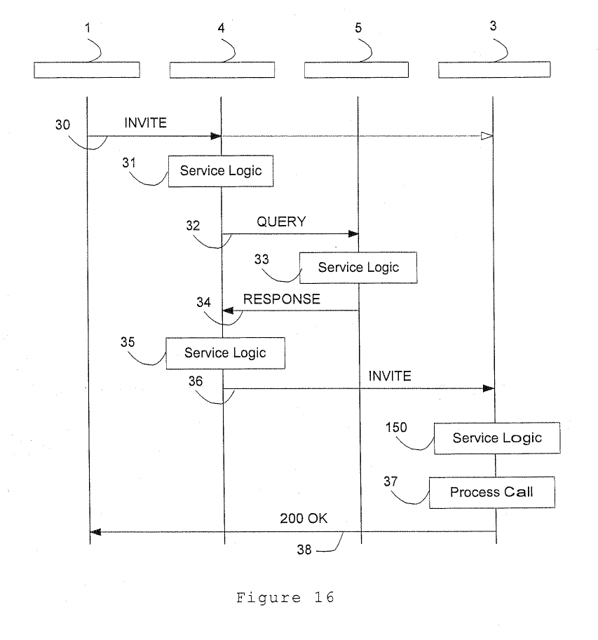

FIG. 16, is the sequence diagram of the sixth embodiment of the invention. This illustrates the session initiation procedures involved in implementing privacy service by both the network hosting a PN Server 4 and the privacy aware Slave Device 2. Guest Device 1 sends an INVITE message to the Slave Device 3 as the destination in step 30. This message is intercepted by the PN Server 4 using the interface 25. The PN Server 4 then processes the request based on the ACL 12, as privacy mode processing in step 31. If the privacy mode processing in step 31 decides to continue with privacy processing, a query is sent with access request information in step 32. In step 33, the query is processed by the privacy decision processing of Master Device 5. The privacy decision processing of step 33 processes the decision of the user, and formats it in the form of a response which is sent in step 34. This response is processed in the privacy response processing of step 35. If the response is positive, the INVITE message of step 30 is sent as normal to the Slave Device 3 in step 36. When the INVITE message is received by the privacy aware Slave Device 2, configuration check of step 150 is performed to check for details of configured-by-node. Once this is checked, the message is processed as normally done by the Slave Device 3 protocol stack in step 37.

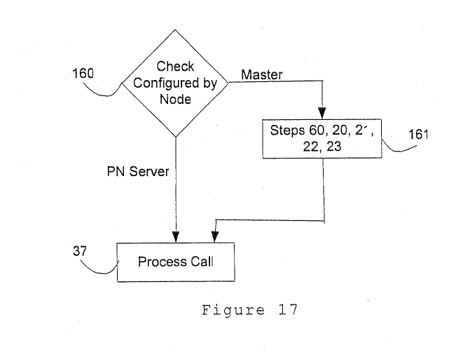

FIG. 17, describes the configuration check of step 150. A check is performed by the ACPU 7 of the configured-by-node stored in the ACL 10 of the privacy aware Slave Device 2. If it has been configured by the Master, the steps of 60, 20, 21, 22 and 23 are performed. If it has been configured by the PN Server 4, the call is processed directly without any need for privacy processing, as in step 37.

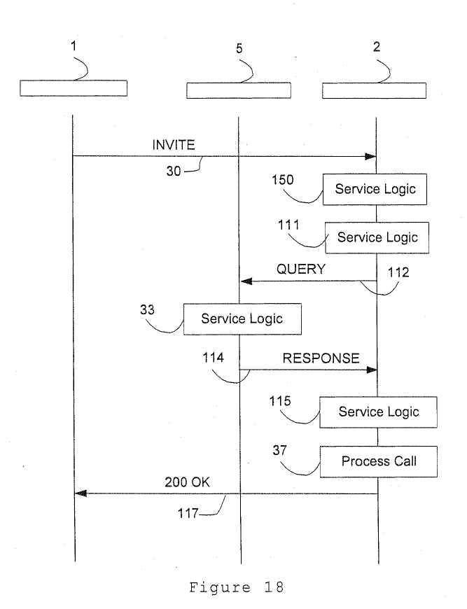

FIG. 18, illustrates the sequence diagram of the seventh embodiment of this invention. The system involves the Guest Device 1, the Master Device 5 and the privacy aware Slave Device 2 which has stored the configured-by-node attribute. An INVITE message is sent from the Guest Device 1 to the privacy aware Slave Device 2 as in step 30. When the INVITE message is received by the privacy aware Slave Device 2, configuration step of step 150 is performed to check for details of configured-by-node. The configuration check at step 150 would indicate that the privacy aware Slave Device 2 has been configured by the Master itself over the interface 24. Thus the privacy aware Slave Device 2 continues with privacy processing of this session request. The privacy aware Slave Device 2 then performs privacy mode processing of step 111, which involves checking privacy status of the privacy aware Slave Device 2, checking registration status of the Guest Device 1, and further processing if required. If the ACPU 7 does not have enough information to process the request as far as privacy is concerned, the ACPU 7 constructs a Query message, and this is sent to the Master Device 5 as in step 112. The PPU 13 of the Master Device 5 processes the Query message as in privacy decision processing of step 33. The privacy decision processing involves requesting the user to make a decision of the access request, and constructing a response message. Once the response message is created, it is sent to the privacy aware Slave Device 2 as in step 114. The privacy aware Slave Device 2 processes the response message as in privacy response processing of step 115. The result of the processing will enable the privacy aware Slave Device 2 to make a decision on whether to continue with call processing. If this is possible, call processing is continued as in step 37.

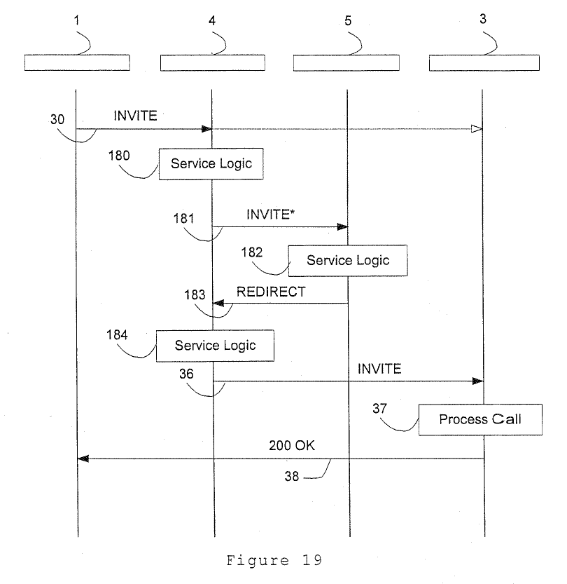

FIG. 19, is the sequence diagram of the eighth embodiment of the invention. This illustrates the session initiation procedures involved in implementing privacy service by the network by hosting a PN Server 4. Guest Device 1 sends an INVITE message to the Slave Device 3 as the destination in step 30. This message is intercepted by the PN Server 4 using the interface 25. The PN Server 4 then processes the request based on the ACL 12, as privacy mode processing in step 180. If the privacy mode processing in step 180 decides to continue with privacy processing, a modified INVITE message is sent with access request information in step 181. In step 182, the modified INVITE is processed by the privacy decision processing of Master Device 5. The privacy decision processing of step 182 processes the decision of the user, and formats it in the form of a REDIRECT response which is sent in step 183. This response is processed in the privacy response processing of step 184. If the response is positive, the INVITE message of step 30 is sent as normal to the Slave Device 3 in step 36. This message is processed as normally done by the Slave Device 3 protocol stack in step 37.

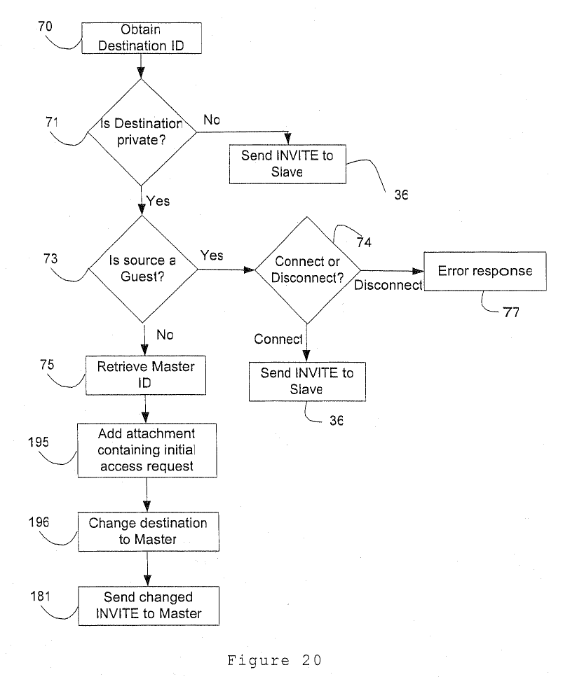

FIG. 20, is the steps involved in the privacy mode processing at step 180. First, the destination identity is obtained from the INVITE request as in step 70. Once this is done, a check is done whether the destination device has been configured as private.

If it is not configured as private, call is processed as normal as in step 36.

If private, another check is done whether the source device or identity is registered as a Guest already, as in step 73. This check is done to verify if the ACL 12 already contains information regarding the Guest. If is registered, or there is already some information regarding the Guest Device 1, a further check is done regarding the detail of the registration/configuration. This can be whether the call is to be connected or disconnected as in step 74. Other details may also be checked such as media information, QoS attributes, service specific filters, but not limited to these. If the entry is to disconnect the call, the PN Server 4 sends an error request as in step 77, usually in the form of a CANCEL message. If the entry is to connect the call, the PN Server 4 continues processing the call by sending the INVITE message to the Slave Device 3 as in step 36.

If the original device hasn't been registered as yet, the PN Server 4 retrieves the Master Device 5 for the particular destination device as in step 75, which is the Slave Device 3 as in this case. Using the access request information present in the initial INVITE, a modified INVITE message is constructed by the PN Server 4. First, an access control attachment consisting of the access request information of the initial INVITE message is added, as in step 195. The destination of the INVITE message is changed to the identity of the Master Device 5, as in step 196. The modified INVITE message is sent to the Master Device 5, as in step 181.

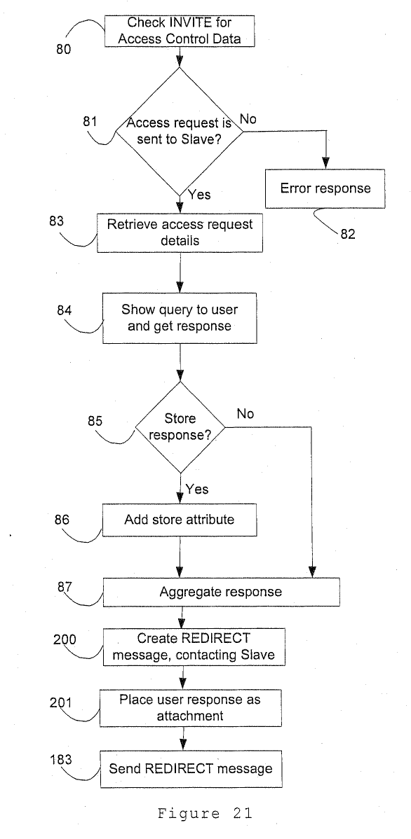

FIG. 21, is the steps involved in step 182. The INVITE message is checked for access control information or attachments by the Master Device 5 as in step 80. When this information is present, it checks whether the detail present refers to its Slave Device 3, as in step 81. If it does not refer to its Slave Device 3, it may send an error report as in step 82. If the access control information does correspond to the Slave Device 3, the PPU 13 retrieves the relevant details from the attachment such as source device, session-type and other session/service relevant information as in step 83. Once these details are collected, the PPU 13 presents these details in graphical/text form to the user as in step 84, requesting his response to this session request. For example, a simple message such as X trying to access Y: Approve or Disapprove, may be shown, where X is the Identity of the Guest Device 1 and Y is the identity of the Slave Device 3. Another feature that could be added is the option to store the user's response as a static entry in the ACL 12 of the PN Server 4, as shown in step 85. If the user wishes to keep his decision as a static entry, this information is added onto the response, as in step 86. Finally the response of the user is aggregated and formed as in step 87. A REDIRECT message is created, with the contact-header providing the address of the Slave Device 3, as in step 200. The user response is placed as an attachment in the REDIRECT message, as in step 201. The REDIRECT response is sent by the Master Device 5 as in step 183.

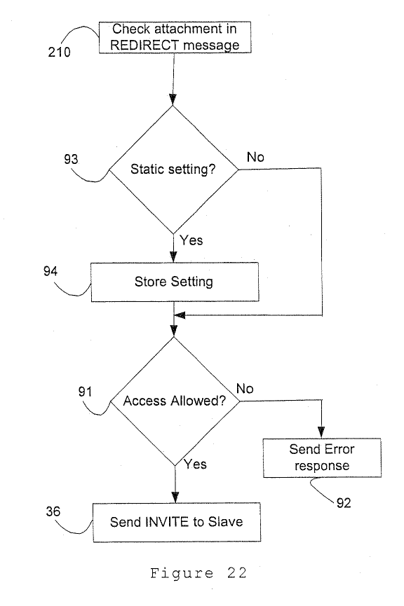

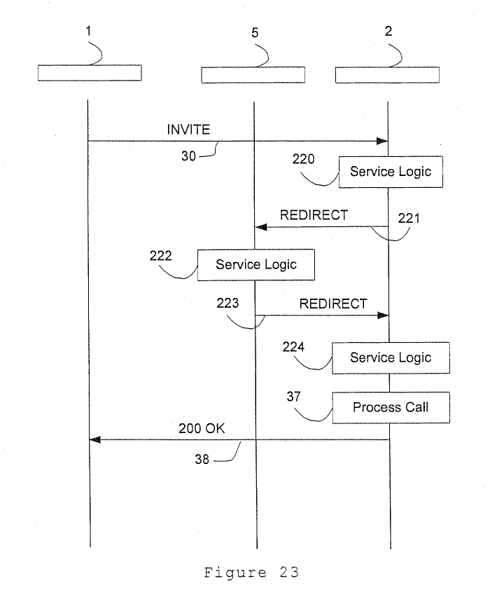

FIG. 22, is the flow chart description of the privacy response processing at step 184. Here, the PN Server 4 (ACPU) receives and checks the REDIRECT message from the Master Device 5 regarding the access control decision as in step 210. First, a check for the static attribute is checked in the response, as in step 93. If the static attribute is present, the relevant entries are stored onto the ACL 12. Next, a check on the actual decision is made, as in step 91. If access has been denied, an error response is sent as in step 92. This could be in form of a CANCEL message. If access is allowed, the INVITE message of step 30 is forwarded to the Slave Device 3, as in step 36.

FIG. 23, is the sequence diagram of the ninth embodiment of the invention. An INVITE message is sent from the Guest Device 1 to the privacy aware Slave Device 2 as in step 30. The privacy aware Slave Device 2 then performs privacy mode processing of step 220, which involves checking privacy status of the privacy aware Slave Device 2, checking registration status of the Guest Device 1, and further processing if required. If the ACPU 7 does not have enough information to process the request as far as privacy is concerned, the ACPU 7 constructs a Query message, and this is sent to the Master Device 5 as in step 221. The PPU 13 of the Master Device 5 processes the Query message as in privacy decision processing of step 222. The privacy decision processing involves requesting the user to make a decision of the access request, and constructing a response message. Once the response message is created, it is sent to the privacy aware Slave Device 2 as in step 223. The privacy aware Slave Device 2 processes the response message as in privacy response processing of step 224. The result of the processing will enable the privacy aware Slave Device 2 to make a decision on whether to continue with call processing. If this is possible, call processing is continued as in step 37.

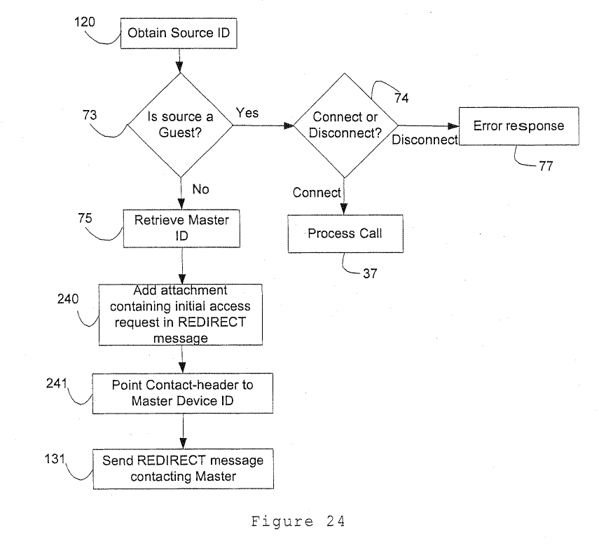

FIG. 24, is the steps involved in the privacy mode processing at step 220. First, the source identity is obtained from the INVITE request as in step 120. A check is done whether the source device or identity is registered as a Guest already, as in step 73. This check is done to verify if the ACL 10 already contains information regarding the Guest. If is registered, or there is already some information regarding the Guest Device 1, a further check is done regarding the detail of the registration/configuration. This can be whether the call is to be connected or disconnected as in step 74. Other details may also be checked such as media information, QoS attributes, service specific filters, but not limited to these. If the entry is to disconnect the call, the privacy aware Slave Device 2 sends an error request as in step 77, usually in the form of a CANCEL message. If the entry is to connect the call, the privacy aware Slave Device 2 continues processing the call by sending the INVITE message to the Slave Device 3 as in step 36.

If the original device hasn't been registered as yet, the privacy aware Slave Device 2 retrieves the Master Device 5 for the particular destination device as in step 75, which is the Master Device 5 as in this case. Using the access request information present in the initial INVITE, a REDIRECT message is constructed by the privacy aware Slave Device 2 to be sent to the Master Device 5 as in step 240. The contact-header of this message is pointed to the identity of the Master Device 5, as in step 241. The REDIRECT response is then sent by the privacy aware Slave Device 2 as in step 131.

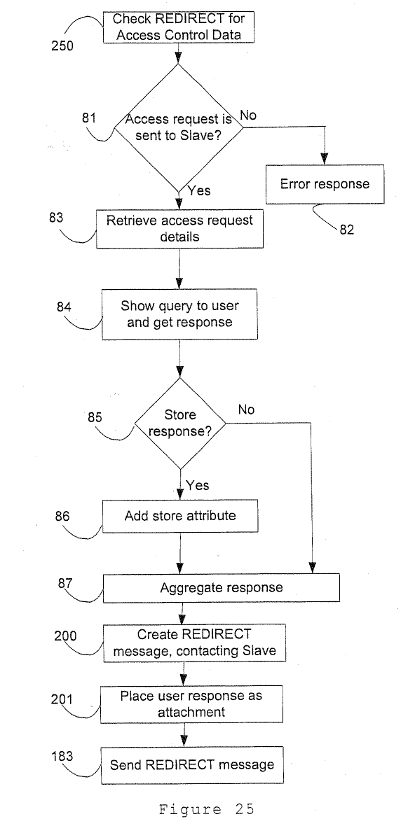

FIG. 25, illustrates the privacy decision processing at the Master Device 5 at step 222. The REDIRECT response is checked for access control information by the Master Device 5 as in step 250. When this information is present, it checks whether the detail present refers to its Slave Device 3. If it does not refer to its Slave Device 3, it may send an error report as in step 82. If the access control information does correspond to the Slave Device 3, the PPU 13 retrieves the relevant details from the attachment such as source device, session-type and other session/service relevant information as in step 83. Once these details are collected, the PPU 13 presents these details in graphical/text form to the user as in step 84, requesting his response to this session request. For example, a simple message such as X trying to access Y: Approve or Disapprove, may be shown, where X is the Identity of the Guest Device 1 and Y is the identity of the Slave Device 3. Another feature that could be added is the option to store the user's response as a static entry in the ACL 12 of the PN Server 4, as shown in step 85. If the user wishes to keep his decision as a static entry, this information is added onto the response, as in step 86. Finally the response of the user is aggregated and formed as in step 87. A REDIRECT message is created, with the contact-header pointing the Slave Device 3 Identity, as in step 200. The user response is then added as an attachment to the REDIRECT response, as in step 201. The REDIRECT message is then sent by the Master Device 5 as in step 183.

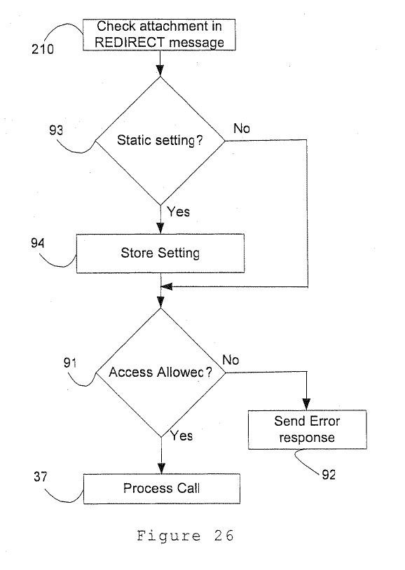

FIG. 26, is the flow chart description of the privacy response processing at step 224. Here, the privacy aware Slave Device 2 (ACPU 7) receives and checks the REDIRECT response from the Master Device 5 regarding the access control decision as in step 210. First, a check for the static attribute is checked in the response, as in step 93. If the static attribute is present, the relevant entries are stored onto the ACL 10. Next, a check on the actual decision is made, as in step 91. If access has been denied, an error response is sent as in step 92. This could be in form of a CANCEL message. If access is allowed, the call is processed further as in step 37.

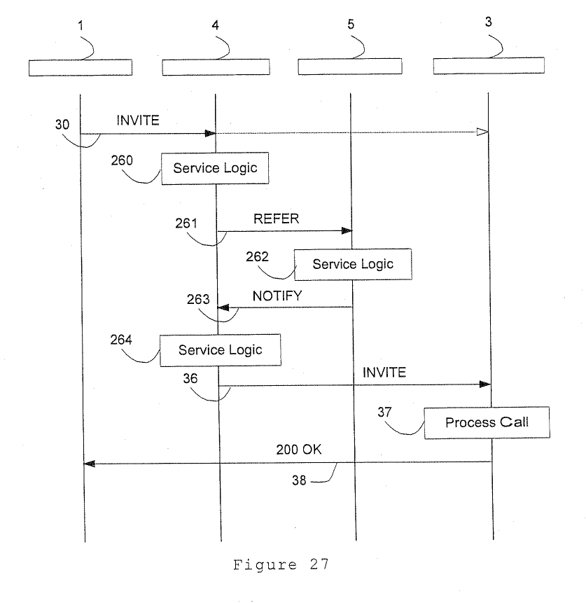

FIG. 27, is the sequence diagram of the tenth embodiment of the invention. This illustrates the session initiation procedures involved in implementing privacy service by the network by hosting a PN Server 4. Guest Device 1 sends an INVITE message to the Slave Device 3 as the destination in step 30. This message is intercepted by the PN Server 4 using the interface 25. The PN Server 4 then processes the request based on the ACL 12, as privacy mode processing in step 260. If the privacy mode processing in step 260 decides to continue with privacy processing, a REFER message is constructed and sent with access request information in step 261. In step 262, the REFER message is processed by the privacy decision processing of Master Device 5. The privacy decision processing of step 262 processes the decision of the user, and formats it in the form of a NOTIFY response which is sent in step 263. This response is processed in the privacy decision processing of step 264. If the response is positive, the INVITE message of step 30 is sent as normal to the Slave Device 3 in step 36. This message is processed as normally done by the Slave Device 3 protocol stack in step 37.

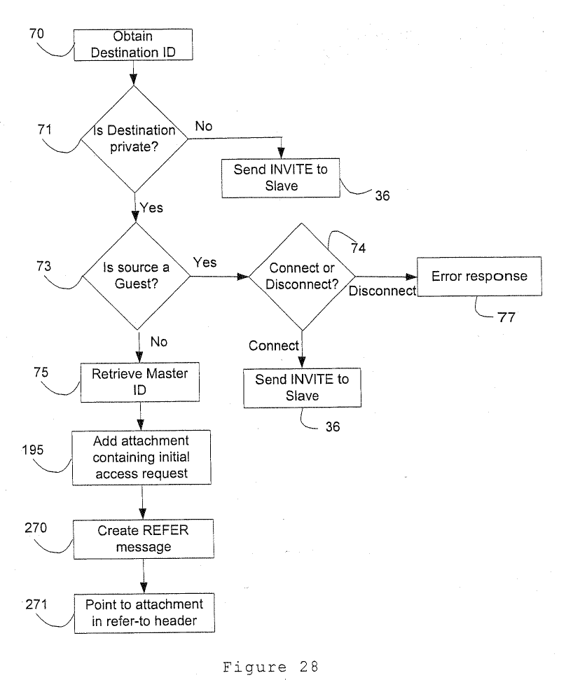

FIG. 28, is the steps involved in the privacy mode processing at step 260. First, the destination identity is obtained from the INVITE request as in step 70. Once this is done, a check is done whether the destination device has been configured as private.

If it is not configured as private, call is processed as normal as in step 36.

If private, another check is done whether the source device or identity is registered as a Guest already, as in step 73. This check is done to verify if the ACL 12 already contains information regarding the Guest. If is registered, or there is already some information regarding the Guest Device 1, a further check is done regarding the detail of the registration/configuration. This can be whether the call is to be connected or disconnected as in step 74. Other details may also be checked such as media information, QoS attributes, service specific filters, but not limited to these. If the entry is to disconnect the call, the PN Server 4 sends an error request as in step 77, usually in the form of a CANCEL message. If the entry is to connect the call, the PN Server 4 continues processing the call by sending the INVITE message to the Slave Device 3 as in step 36.

If the original device hasn't been registered as yet, the PN Server 4 retrieves the Master Device 5 for the particular destination device as in step 75, which is the Slave Device 3 as in this case. Using the access request information present in the initial INVITE, a REFER message is constructed by the PN Server 4. First, an access control attachment consisting of the access request information of the initial INVITE message is added, as in step 195. The REFER message is directed to the Master Device 5, with the refer-to header pointing to the attachment containing the access control information, as in step 270. The REFER message is then sent to the Master Device 5, as in step 271.

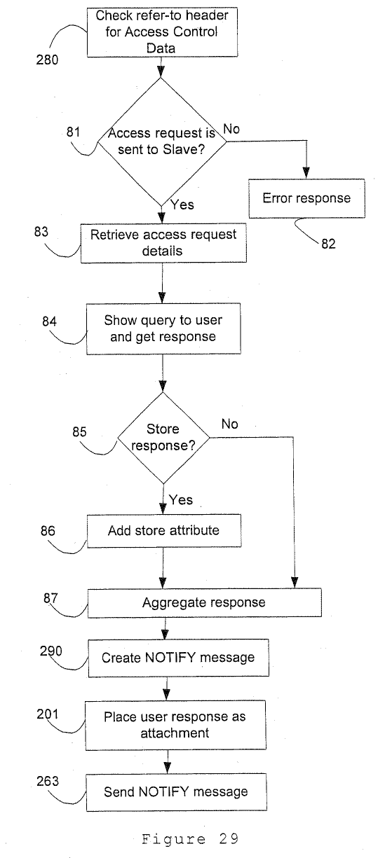

FIG. 29, is the steps involved in step 262. The REFER message is checked for access control information or attachments by the Master Device 5 as in step 280. When this information is present, it checks whether the detail present refers to its Slave Device 3 as in step 81. If it does not refer to its Slave Device 3, it may send an error report as in step 82. If the access control information does correspond to the Slave Device 3, the PPU 13 retrieves the relevant details from the attachment such as source device, session-type and other session/service relevant information as in step 83. Once these details are collected, the PPU 13 presents these details in graphical/text form to the user as in step 84, requesting his response to this session request. For example, a simple message such as X trying to access Y: Approve or Disapprove, may be shown, where X is the Identity of the Guest Device 1 and Y is the identity of the Slave Device 3. Another feature that could be added is the option to store the user's response as a static entry in the ACL 12 of the PN Server 4, as shown in step 85. If the user wishes to keep his decision as a static entry, this information is added onto the response, as in step 86. Finally the response of the user is aggregated and formed as in step 87. A NOTIFY message is created, directed at the PN Server 4, as in step 290. The user response is placed as an attachment in the NOTIFY message, as in step 201. The NOTIFY response is sent by the Master Device 5 as in step 263.

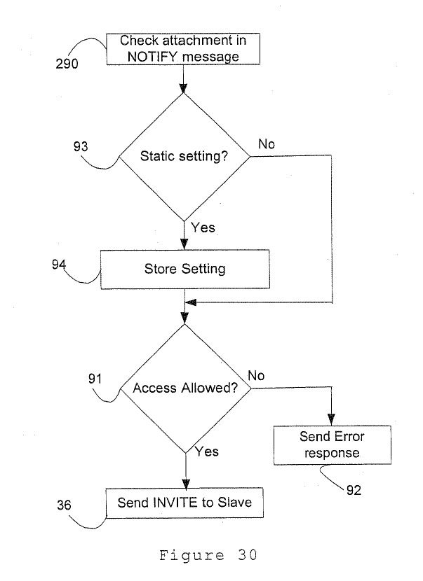

FIG. 30, is the flow chart description of the privacy response processing at step 264. Here, the PN Server 4 (ACPU 14) receives and checks the NOTIFY message from the Master Device 5 regarding the access control decision as in step 290. First, a check for the static attribute is checked in the response, as in step 93. If the static attribute is present, the relevant entries are stored onto the ACL 12. Next, a check on the actual decision is made, as in step 91. If access has been denied, an error response is sent as in step 92. This could be in form of a CANCEL message. If access is allowed, the INVITE message of step 30 is forwarded to the Slave Device 3, as in step 36.

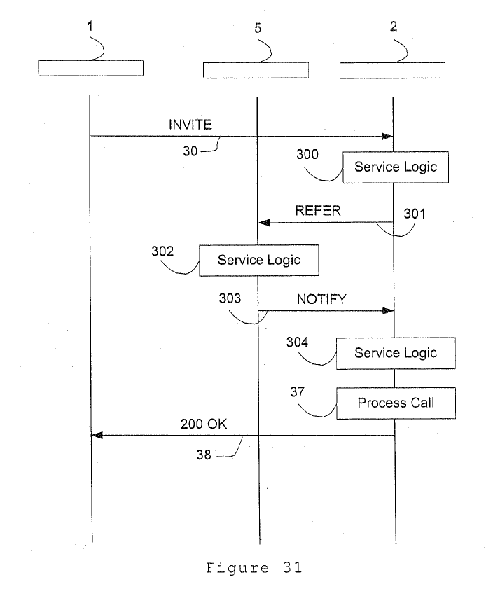

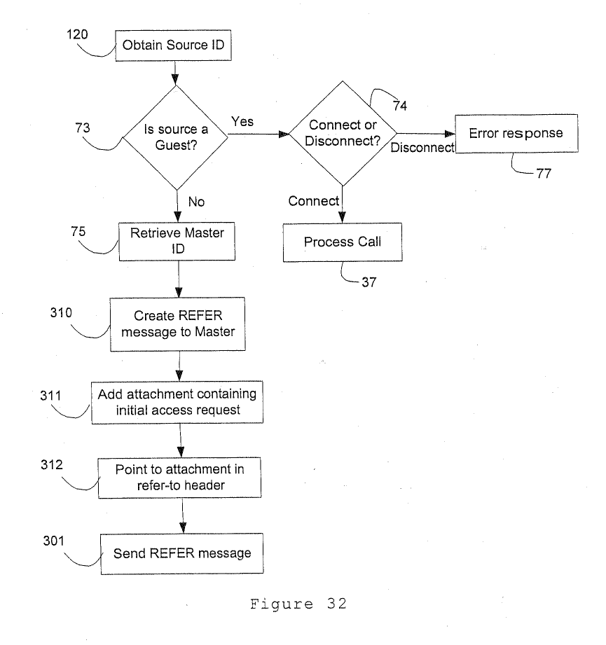

FIG. 31, is the sequence diagram of the eleventh embodiment of the invention. An INVITE message is sent from the Guest Device 1 to the privacy aware Slave Device 2 as in step 30. The privacy aware Slave Device 2 then performs privacy mode processing of step 300, which involves checking privacy status of the privacy aware Slave Device 2, checking registration status of the Guest Device 1, and further processing if required. If the ACPU 7 does not have enough information to process the request as far as privacy is concerned, the ACPU 7 constructs a REFER message, and this is sent to the Master Device 5 as in step 301. The PPU 13 of the Master Device 5 processes the REFER message as in privacy decision processing of step 302. The privacy decision processing involves requesting the user to make a decision of the access request, and constructing a NOTIFY response message. Once the NOTIFY response message is created, it is sent to the privacy aware Slave Device 2 as in step 303. The privacy aware Slave Device 2 processes the response message as in privacy response processing of step 304. The result of the processing will enable the privacy aware Slave Device 2 to make a decision on whether to continue with call processing. If this is possible, call processing is continued as in step 37.

FIG. 32, is the steps involved in the privacy mode processing at step 300. First, the source identity is obtained from the INVITE request as in step 120. A check is done whether the source device or identity is registered as a Guest already, as in step 73. This check is done to verify if the ACL 10 already contains information regarding the Guest. If is registered, or there is already some information regarding the Guest Device 1, a further check is done regarding the detail of the registration/configuration. This can be whether the call is to be connected or disconnected as in step 74. Other details may also be checked such as media information, QoS attributes, service specific filters, but not limited to these. If the entry is to disconnect the call, the privacy aware Slave Device 2 sends an error request as in step 77, usually in the form of a CANCEL message. If the entry is to connect the call, the privacy aware Slave Device 2 continues processing the call by sending the INVITE message to the Slave Device 3 as in step 36.

If the original device hasn't been registered as yet, the privacy aware Slave Device 2 retrieves the Master Device 5 for the particular destination device as in step 75, which is the Master Device 5 as in this case. Using the access request information present in the initial INVITE, a REFER message is constructed by the privacy aware Slave Device 2 to be sent to the Master Device 5 as in step 310. The refer-to-header of this message is pointed to the access request information of the initial INVITE message, as in step 311. The REFER message is then sent by the privacy aware Slave Device 2 as in step 301.

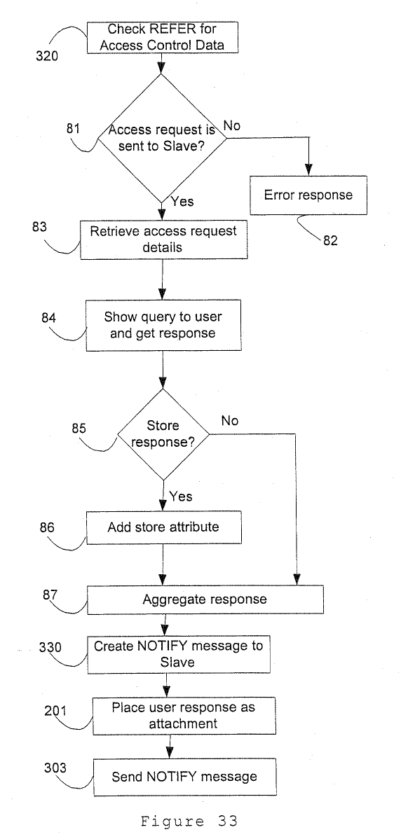

FIG. 33, illustrates the privacy decision processing at the Master Device 5 at step 302. The REFER message is checked for access control information by the Master Device 5 as in step 320. When this information is present, it checks whether the detail present refers to its privacy aware Slave Device 2 as in step 81. If it does not refer to its privacy aware Slave Device 2, it may send an error report as in step 82. If the access control information does correspond to the privacy aware Slave Device 2, the PPU 13 retrieves the relevant details from the attachment such as source device, session-type and other session/service relevant information as in step 83. Once these details are collected, the PPU 13 presents these details in graphical/text form to the user as in step 84, requesting his response to this session request. For example, a simple message such as X trying to access Y: Approve or Disapprove, may be shown, where X is the Identity of the Guest Device 1 and Y is the identity of the privacy aware Slave Device 2.

Another feature that could be added is the option to store the user's response as a static entry in the ACL 12 of the PN Server 4, as shown in step 85. If the user wishes to keep his decision as a static entry, this information is added onto the response, as in step 86. Finally the response of the user is aggregated and formed as in step 87. A NOTIFY message is created, directed to the privacy aware Slave Device 2, as in step 330. The user response is then added as an attachment to the NOTIFY response, as in step 201. The NOTIFY message is then sent by the Master Device 5 as in step 303.

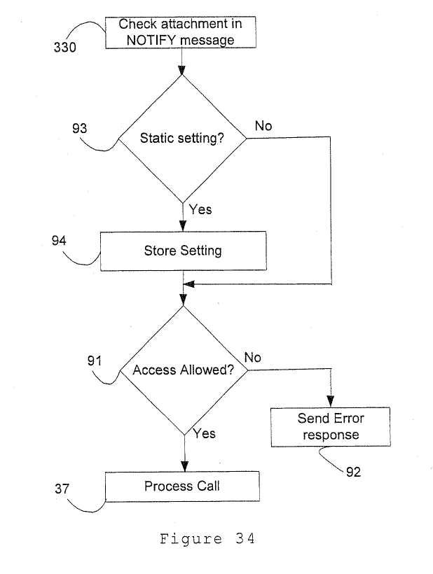

FIG. 34, is the flow chart description of the privacy response processing at step 304. Here, the privacy aware Slave Device 2 (ACPU 7) receives and checks the NOTIFY response from the Master Device 5 regarding the access control decision as in step 330. First, a check for the static attribute is checked in the response, as in step 93. If the static attribute is present, the relevant entries are stored onto the ACL 10, as in step 94. Next, a check on the actual decision is made, as in step 91. If access has been denied, an error response is sent as in step 92. This could be in form of a CANCEL message. If access is allowed, the call is processed further as in step 37.

Another embodiment is the use of forking by the PN Server, where instead of waiting for the response of the Master Device when a Query regarding access control is sent, the PN Server could continue with session initiation as normal. If no information is received from the Master Device, a normal session can be carried out. Whereas if the PN Server receives a response during the session initiation, it may issue a cancel request.

1. A system of access control in a data communication network comprising:
a. a privacy unaware Guest Device
b. a privacy unaware Slave device
c. a PN Server
d. and a Master Device
wherein the access of a privacy unaware Slave device by a privacy unaware Guest Device is restricted by a PN Server, which intercepts all session initiations concerned with the Slave Device.

2-116. (canceled)
